(19) United States
(12) Patent Application Publication
(10) Pub. No.: US 2012/0097822 A1
(43) Pub. Date: Apr. 26, 2012

(54) SEAT SUSPENSION ARRANGEMENT AND METHOD FOR PRESTRESSING A GUIDE ASSEMBLY

(75) Inventor: Matthias Hammarskiöld, Örebro (SE)

(73) Assignee: Volvo Construction Equipment, Eskilstuna (SE)

(21) Appl. No.: 13/139,735

(22) PCT Filed: Dec. 15, 2008
(86) PCT No.: PCT/SE2008/000705

§ 371 Date: Sep. 6, 2011

(51) Int. Cl. B60N 2/16; B23P 11/00; B60N 2/50

(52) U.S. Cl. 248/421; 29/446

(57) ABSTRACT

A seat suspension arrangement includes an upper structure for receiving a seat and a lower structure for mounting the seat in a work machine or vehicle. The tipper structure and the lower structure are interconnected by at least one intermediate structure and displaceable towards and away from each other. The seat suspension arrangement includes a guide rail and a guided member which is connected to the intermediate structure and arranged at the guide rail. The guided member is arranged to be displaced forwards and backwards along the guide rail when the upper structure and the lower structure are displaced relative to each other.

### BACKGROUND AND SUMMARY

The present invention relates to a seat suspension arrangement.

The invention will be described for an articulated hauler. This should however be regarded as a non-limiting example, wherein the invention may be realized in other types of vehicles or work machines, such as for example wheel loaders.

The term “work machine” comprises different types of material handling vehicles like construction machines, such as a wheel loader and a dump truck (such as an articulated hauler). A work machine is provided with a bucket, container or other type of work implement for carrying/transporting a load. Further terms frequently used for work machines are “earth-moving machinery”, “off-road work machines” and “construction equipment”.

In connection with transportation of heavy loads, e.g. in contracting work, work machines are frequently used. A work machine may be operated with large and heavy loads in areas where there are no roads, for example for transports in connection with road or tunnel building, sand pits, mines and similar environments.

Vehicle seats of today are generally provided with a seat suspension arrangement. In order to provide comfortable conditions for occupants in the vehicle, the seat suspension arrangement is preferably adapted to allow a displacement of the seat relative the vehicle. As such, should the vehicle for instance be driven on a bumpy road, such a seat suspension arrangement may at least partially reduce the accelerations imparted on the seat and hence on a person using the seat.

A seat suspension arrangement allowing a relative displacement of the seat often includes one or more guide arrangements. The aforementioned guide arrangement generally includes a guide rail and a guided member arranged in the guide rail. Moreover, the guided member is generally displaceable forwards and backwards along the guide rail in order to provide the aforesaid relative displacement and/or adjustability of the seat.

Generally, at least a portion of the guided member is adapted to contact at least a portion of the guide rail. If the guided member only intermittently contacts the guide rail the occupant of the seat connected thereto may be subjected to injuries due to vibrations imparted on the occupant. Moreover, the intermittent contact may result in a rattling noise from the seat suspension arrangement.

As such, in order to provide a comfortable driving condition for the occupant of the seat, it is generally desired to ensure that the guided member always—or at least substantially always—contacts at least a portion of the guide rail. In other words, it is generally desired to have a zero vertical play between the guided member and the guide rail.

In order to obtain the aforesaid constant contact between the guided member and the guide rail, DE 10 2005 005 889 proposes a guide arrangement wherein the guided member comprises two rollers with different diameters. The larger roller is adapted to contact only a lower contact surface of the guide rail whereas the smaller roller is adapted to contact only an upper contact surface of the guide rail. The diameters of the rollers and the distance between the upper and lower contact surfaces may be selected such that the rollers are pressed towards the respective contact surface. However, it should be noted that the '889 solution imparts an increased pressure on the rollers in order to obtain the zero vertical play.

It is desirable to provide a seat suspension arrangement with a guide arrangement comprising a guide rail and a guided member, wherein the vertical play between the guide rail and the guided member may be kept to a minimum—preferably zero—without risking that the guided member is subjected to excessive loads.

Thus, an aspect of the present invention relates to a seat suspension arrangement comprising an upper structure for receiving a seat and a lower structure for mounting the seat in a work machine or vehicle. The upper structure and the lower structure are interconnected by at least one intermediate structure and displaceable towards and away from each other. The seat suspension arrangement comprises a guide rail and a guided member which is connected to the intermediate structure and arranged at the guide rail. The guided member is arranged to be displaced forwards and backwards along the guide rail when the upper structure and the lower structure are displaced relative to each other.

According to an aspect of the present invention, the guided member is connected to the intermediate structure by means of a connection member which is pivotally connected to the intermediate structure at a pivot point. Moreover, the guided member is connected to the connection member at a distance from the pivot point. Further, the seat suspension arrangement comprises a biasing means adapted to impart a torque around the pivot point on the connection member to thereby bias the guided member towards the guide rail.

As such, by a seat suspension arrangement according to an aspect of the present invention, a low—or even zero—vertical play between the guided member and the guide rail may be obtained without an excessive loading of the guided member. Moreover, the low vertical play is obtained by the functions of the biasing means and the connection member rather than the guided member itself. As such, the design of the guided member may focused on obtaining a guided member with appropriate load transferring and displacing characteristics, which generally provides for that a cost efficient design of the guided member may be obtained.

In another embodiment of the present invention, the biasing means is a torsion bar. A first portion of the torsion bar is fixedly attached to the connection member at the pivot point. The torsion bar may provide for that the biasing means may be prestressed after the seat suspension arrangement has been assembled, which will be explained further hereinbelow.

In a further embodiment of the present invention, the guide rail comprises a first and a second guide surface wherein the first and second guide surfaces are located on opposite sides of the guided member. The seat suspension arrangement further comprises a second guided member connected to the connection member and the first and second guided members are preferably located on either side of the pivot point.

With a seat suspension according to the above, it may be ensured that vertical vibrations in the seat suspension arrangement are reduced even further since both positive and negative vertical displacements of the guided members in relation to the guide rail may be significantly reduced and sometimes even omitted.

In a further embodiment of the present invention, the intermediate structure comprises a first link member and a second link member at least partially forming a substantially X-shaped link comprising four connection arrangements wherein a first and a second connection arrangement connects the X-shaped link and the upper structure and a third and a fourth connection arrangement connects the X-shaped link and the lower structure to thereby enable that the position of the upper structure in relation to the lower structure may be changed.

In another embodiment of the present invention, the seat suspension arrangement comprises two intermediate structures wherein a first intermediate structure comprises a first guided member and a second intermediate structure comprises a second guided member. The first and second guided members are connected to a common biasing means.

The feature of a common biasing means is advantageous, since this provides for that two guided members may be prestressed simultaneously.

A second aspect of the present invention relates to a vehicle, preferably a truck or a work machine, comprising a seat suspension arrangement according to an aspect of the present invention.

A third aspect of the present invention relates to a method of prestressing a guide assembly of a seat suspension arrangement. The guide assembly comprises a torsion bar a first portion of which is fixedly attached to a connection member at a pivot point. The guide assembly further comprises a guided member being connected to the connection member at a distance from the pivot point. The guide assembly further comprises a guide rail along which guide rail the guided member is adapted to be displaced forwards and backwards. The method of the third aspect of the present invention comprises the steps of:
a) positioning the guided member relative to the guide rail such that at least a portion of the guided member and at least a portion of the guide rail overlap;
b) imparting a rotation from a first rotational position to a second rotational position of a second portion of the torsion bar to thereby bias the guided member towards the guide rail, and c) locking the second portion in the second rotational position from rotation.

### BRIEF DESCRIPTION OF THE DRAWINGS

With reference to the appended drawings, below follows a more detailed description of embodiments of the invention cited as examples:

FIG. 1 illustrates a vehicle with a seat suspension arrangement of the present invention;

FIG. 2 illustrates a schematic perspective view of an embodiment of the seat suspension arrangement the present invention;

FIG. 3 illustrates a detailed view of a portion of an embodiment of a seat suspension arrangement of the present invention;

FIG. 4 illustrates a detailed view of a portion of another embodiment of a seat suspension arrangement of the present invention;

FIG. 5 illustrates a detailed view of a portion of a further embodiment of a seat suspension arrangement of the present invention;

FIG. 6 illustrates the FIG. 5 seat suspension arrangement during a first stage of a prestressing method;

FIG. 7 illustrates the FIG. 5 seat suspension arrangement during a second stage of a prestressing method, and

FIG. 8 illustrates a detailed view of yet another embodiment of the seat suspension arrangement.

### DETAILED DESCRIPTION

The invention will be described using examples of embodiments. It should however be realized that the embodiments are included in order to explain principles of the invention and not to limit the scope of the invention, defined by the appended claims.

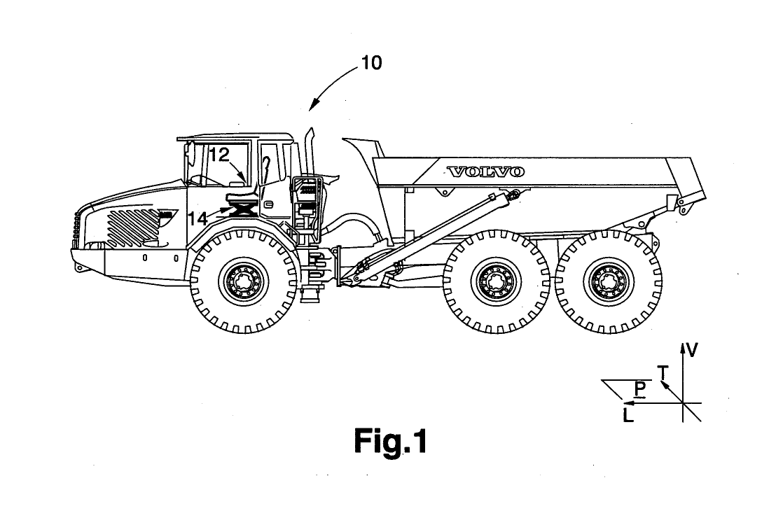

FIG. 1 schematically illustrates a vehicle 10 which is exemplified by a work machine. The work machine 10 comprises a seat 12 with a seat suspension arrangement 14.

FIG. 1 further illustrates that the vehicle 10 has a longitudinal dimension L extending between the rear to the front of the vehicle 10. Furthermore, the vehicle 10 has a transversal dimension T extending from one side to the other of the vehicle 10 and a vertical dimension V the direction of which is perpendicular to both the longitudinal L and transversal T dimensions. The longitudinal L and transversal T dimensions together form a plane P. If the vehicle 10 is located on a horizontally extending flat surface, the plane P will extend horizontally.

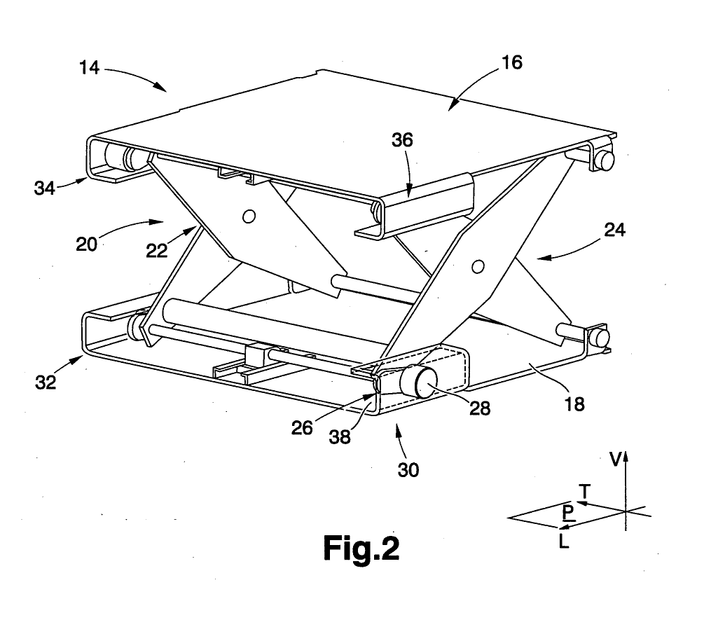

FIG. 2 illustrates a perspective schematic view of an embodiment of the seat suspension arrangement 14 of the present invention. As may be gleaned from FIG. 2, the seat suspension arrangement 14 comprises an upper structure 16 for receiving the seat 12 and a lower structure 18 for mounting the seat 12 in the vehicle 10.

The upper structure 16 is in the FIG. 2 embodiment exemplified by a plate but the upper structure 16 may in other embodiments of the present invention comprise a frame, a truss system or similar (not shown). The upper structure 16 is generally adapted to be connected to a seat of the vehicle or optionally to form a part of a seat.

The lower structure 18 is in the FIG. 2 embodiment also exemplified by a plate but as for the upper structure 16, the lower structure 18 may in other embodiments of the present invention comprise a frame, a truss system or similar (not shown). The lower structure 18 is generally adapted to be connected to a structure—such as the bottom plate—of the vehicle (not shown in FIG. 2). Optionally, the lower structure 18 may be formed as a part of a vehicle structure—such as the bottom plate.

Purely by way of example, the length and width of the upper structure 16 and the lower structure 18 may be within the range of 300-400 mm.

FIG. 2 further illustrates that the upper structure 16 and the lower structure 18 are interconnected by at least one intermediate structure 20. The upper structure 16 and the lower structure 18 are displaceable towards and away from each other, at least in the vertical dimension V.

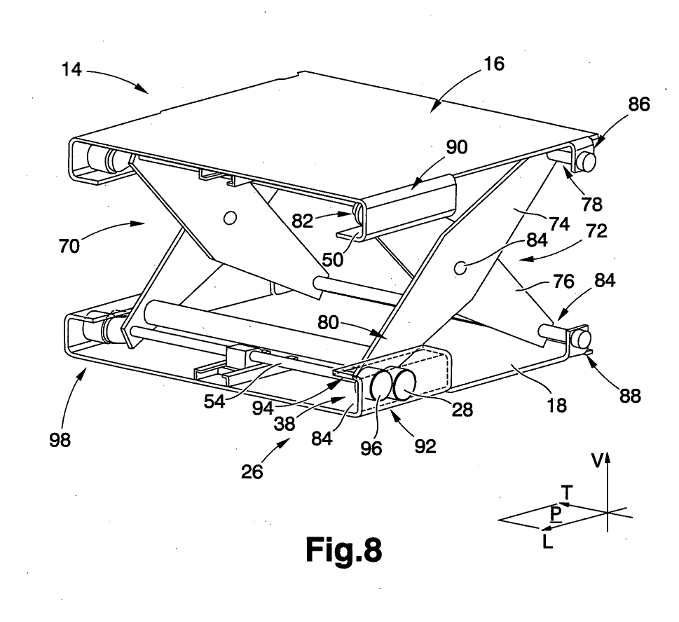

As may be gleaned from FIG. 2, the intermediate structure 20 illustrated therein comprises two substantially X-shaped links 22, 24 the features and functions of which will be presented more thoroughly below with reference to FIG. 8. However, in other embodiments of the seat suspension arrangement 14 of the present invention, the design of the intermediate structure 20 may be different from the FIG. 2 design while still being able to provide a relative displacement of the upper structure 16 and the lower structure 18.

However, irrespective of the design of the intermediate structure 20, the seat suspension arrangement 14 of the present invention comprises a guide rail 26 and a guided member 28. The guided member 28 is connected to the intermediate structure 20 and arranged at the guide rail 26. The guided member 28 is arranged to be displaced forwards and backwards along the guide rail 26 preferably when the upper structure 16 and the lower structure 18 are displaced relative to each other.

The guide rail 26 and a guided member 28 may be regarded as forming parts of a guide assembly 30 of the seat suspension arrangement 14. As may be realized from FIG. 2, the seat suspension arrangement 14 illustrated therein comprises four such guide assemblies 30, 32, 34, 36.

In the embodiment of the seat suspension arrangement 14 illustrated in FIG. 2, the forward and backward displacement of the guided member 28 is performed substantially along the longitudinal dimension L. However, in other embodiments of the seat suspension arrangement 14, the aforesaid forward and backward displacement may be performed along another dimension which may preferably, although not necessarily, extend parallel to the horizontal plane P.

Moreover, in the implementation of the guide assembly 30 illustrated in FIG. 2, the guided 35 member 28 comprises a roll 28 adapted to roll on a first guide surface 38 of the guide rail 26. However, in other implementations of the guide assembly 30, the guided member 28 may be of another type. Purely by way of example, the guided member 28 may be a sliding member (not shown) adapted to slide on the first guide surface 38.

Purely by way of example, the roll 28 may be of steel. Again purely by way of example, the diameter of the roll 28 may be within the range of 20-30 mm.

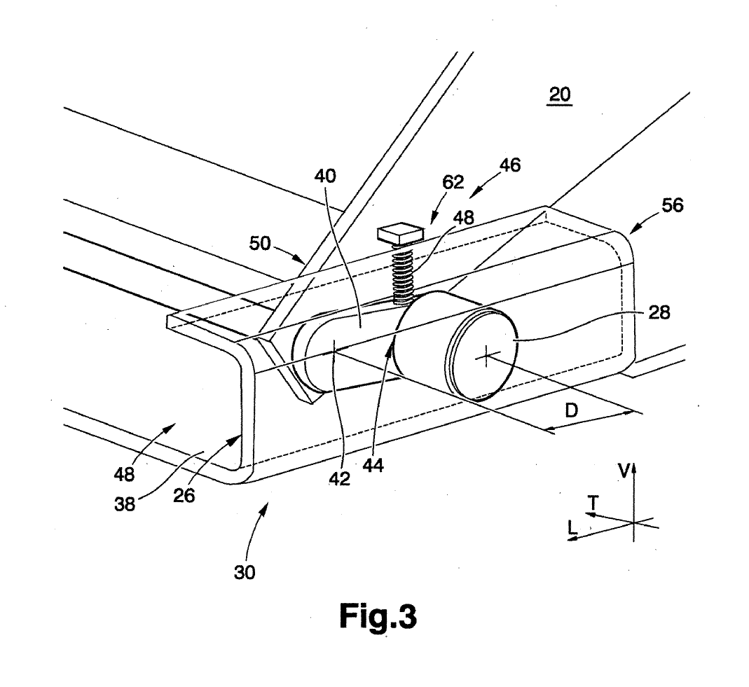

FIG. 3 illustrates a detailed view of the FIG. 2 guide assembly 30. As may be gleaned from FIG. 3, the guided member 28 is connected to the intermediate structure 20 by means of a connection member 40 which is pivotally connected to the intermediate structure 20 at a pivot point 42.

In the FIG. 3 implementation of the guide assembly 30, the connection member 40 is a bracket which bracket preferably is made of metal such as steel. However, in other implementations of the guide assembly 30, the connection member 40 may be a bar, a rod or any other means adapted to provide a connection—preferably a substantially rigid connection—between the pivot point 42 and the guided member 28.

The guide assembly 30 comprises an attachment means or attachor 44 adapted to provide the connection of the guided member 28 to the connection member 40. If the guided member 28 is adapted to slide on the guide rail 26, the attachment means 44 is preferably adapted to provide a pivotable connection of the guided member 28 and the connection member 40. Purely by way of example, the attachment means 44 may in such a case comprise a hinge and/or a slewing bracket (not shown).

However, if the guided member 28 comprises a roller—as is the case in the FIG. 3 implementation of the guide assembly 30—the attachment means 44 is preferably adapted to provide a rotatable attachment between the guided member 28 and the connection member 40. To this end, the attachment means 44 preferably comprises a bearing—such as a slide, roller, ball or needle bearing (not shown)—a first portion of which is attached to the connection member 40 and a second portion of which is attached to the guided member 28. Purely by way of example, the attachment means 44 may comprise a shaft pivot (not shown) fixedly attached to the connection member 40. Moreover, again purely by way of example, the attachment means 44 may further comprise a needle bearing which is at least partially inserted in an opening (not shown) of the roller 52. An inner ring of the needle bearing may at least partially enclose and be fixedly attached to the shaft pivot. An outer ring of the needle bearing may be fixedly attached to the roller 52.

Moreover, the guided member 28—i.e. the roller in FIG. 3—is connected to the connection member 40 at a distance from the pivot point 42. Further, the seat suspension arrangement 14 comprises a biasing means or biaser 46 adapted to impart a torque around the pivot point 42 on the connection member 40 to thereby bias the guided member 28 towards the guide rail 26.

The biasing means 46 may be designed in a plurality of ways. In the implementation of the guide assembly 30 illustrated in FIG. 3, the biasing means 46 comprises a spring 48—which spring in FIG. 3 is exemplified by a helical spring—which spring 48 is attached to a portion of the intermediate structure 20 and a portion of the connection member 40. In the implementation of the guide assembly 30 illustrated in FIG. 3, the spring 48 is attached to the intermediate structure 20 at a position close to the intermediate structure lower end 50. Preferably, the spring 48 is compressed in order to produce an outwardly directed biasing force substantially in the longitudinal direction of the spring 48.

Although the biasing means biasing means 46 has been exemplified by a helical spring 48 in the FIG. 3 implementation of the guide assembly 30 it should be noted that the other means by be used for biasing the guided member 28 towards the guide rail 26. Purely by way of example, the biasing means 46 may comprise a plate spring or rubber spring (not shown). Again, purely by way of example, instead of or in addition to—a spring, the biasing means may comprise an actuator which for instance is operated by electric, hydraulic and/or pneumatic means (not shown).

When the biasing means 46 imparts a torque on the connection member 40 the guided member 28 will be pressed towards the guide rail 26. In the implementation of the guide assembly 30 illustrated in FIG. 3, the guided member 28 will be pressed downwardly towards the first guide surface 38 of the guide rail 26 such that a low—preferably zero play—will be obtained between the guided member 28 and the guide rail 28.

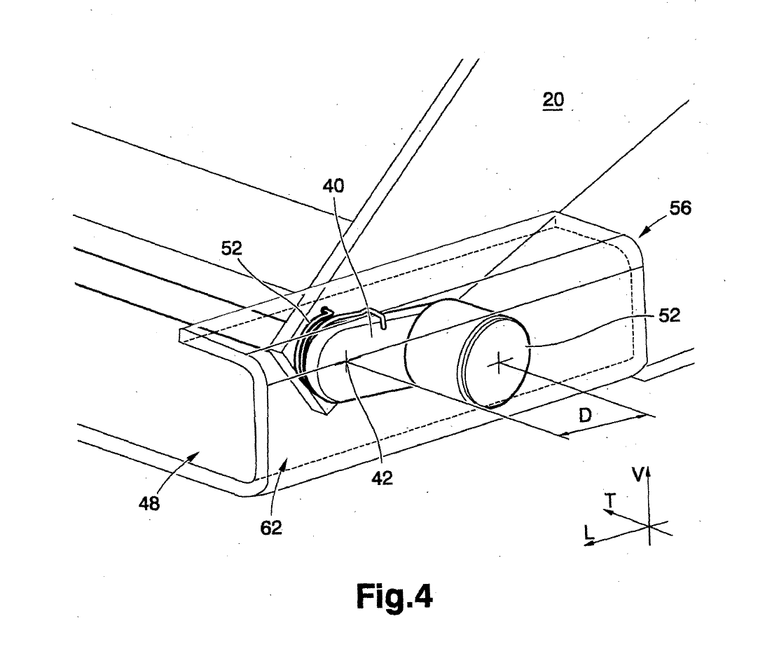

FIG. 4 illustrates another implementation of the guide assembly 30 wherein the biasing means 46 comprises a helical torsion spring 52. The helical torsion spring 52 biased so as to impart a torque around the pivot point 42 to thereby bias the guided member 28 towards the guide rail 26. A first portion of the helical torsion spring 52 is preferably attached to the intermediate structure 20 at a position close to the intermediate structure lower end 32. A second portion of the helical torsion spring 52 is attached to the connection member 40, preferably at a location at a distance from the pivot point 42.

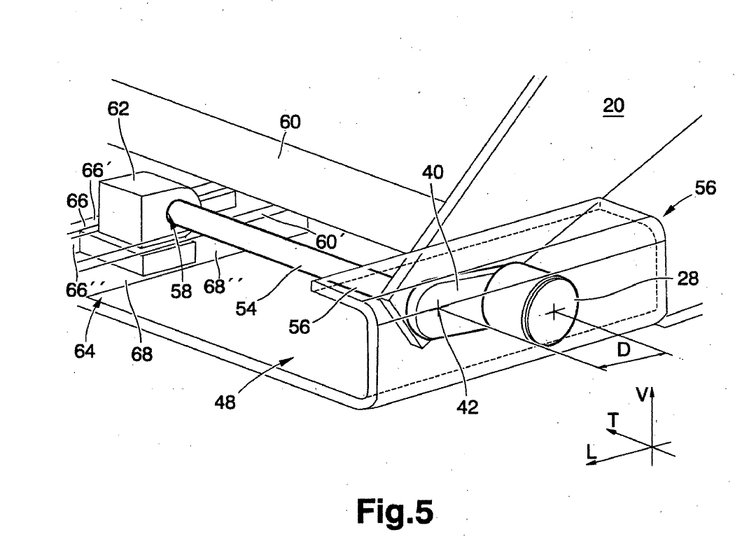

FIG. 5 illustrates a further implementation of the guide assembly 30 wherein the biasing means 46 comprises a torsion bar 54. A first portion 56 of the torsion bar 54 is fixedly attached to the connection member 40 at the pivot point 42. The torsion bar 54 is preferably made of metal, preferably steel. Purely by way of example, the torsion bar may have a circular cross section with a diameter in the range of 6-10 mm.

The torsion bar 54 could in other implementations by of other materials, for instance other types of metal (not shown). Optionally, the torsion bar could be made of for instance a plastics material.

As may be gleaned from FIG. 5, the torsion bar 54 illustrated therein extends through an opening in the intermediate structure 20. Preferably, the torsion bar 54 is also journalled in bearings, such as slide bearings or roller bearings, in the intermediate structure 20.

A second portion 58 of the torsion bar 54 is locked from rotation relative to the first portion 56. To this end, the second portion 58 may be fixedly attached to the seat suspension arrangement 14, or any other part of the vehicle 10, such that the second portion 58 does not move relative to the first portion 56. In this case, the torsion bar 54 preferably has an appropriate bending flexibility in order to allow that the guided member 28 may be displaced in relation to the guide rail 26.

Purely by way of example, if the guide assembly 30 is connecting the lower structure 18 and the intermediate structure 20, the aforementioned attachment may be obtained by fixedly attaching the second portion 58 to the lower structure 18, for instance by means of a bolt or weld joint (not shown).

However, in order to reduce the stresses in the torsion bar 54, the second portion 58 is preferably fixedly attached to a portion of the seat suspension arrangement 14 such that the second portion 58 moves substantially uniformly with the first portion 56 at least in the longitudinal dimension L. Purely by way of example, this may be attained by fixedly attaching the second portion 58 to a member of the seat suspension arrangement 14 which member is displaced forwards and backwards as the guided member 28 is displaced forwards and backwards. An example of such a member is the crossbar 60 illustrated in FIG. 5.

More preferred, the second portion 58 of the torsion bar 54 is slidably connected, optionally fixedly attached, to a carrier 62. The carrier 62 is adapted to perform a translational displacement which is substantially uniform with a translational displacement of the pivot point 42.

To this end, the carrier 62 is preferably slidably connected to a control means or controller 64. In the embodiment of the seat suspension arrangement illustrated in FIG. 5, the control means 64 comprises two substantially longitudinally extending control rims 66, 68 located on either side of the carrier 62 in the transversal dimension T. As may be gleaned from FIG. 5, each one of the control rims 66, 68 comprises a substantially horizontally extending flange 66′, 68′ and a web 66″, 68″ rigidly connecting the flange 66′, 68′ and bottom structure 18. The bottom structure 18 is in turn rigidly connected to the guide rail 26. As such, the carrier 62 is prevented from being displaced transversally as well as vertically in relation to the guide rail 26.

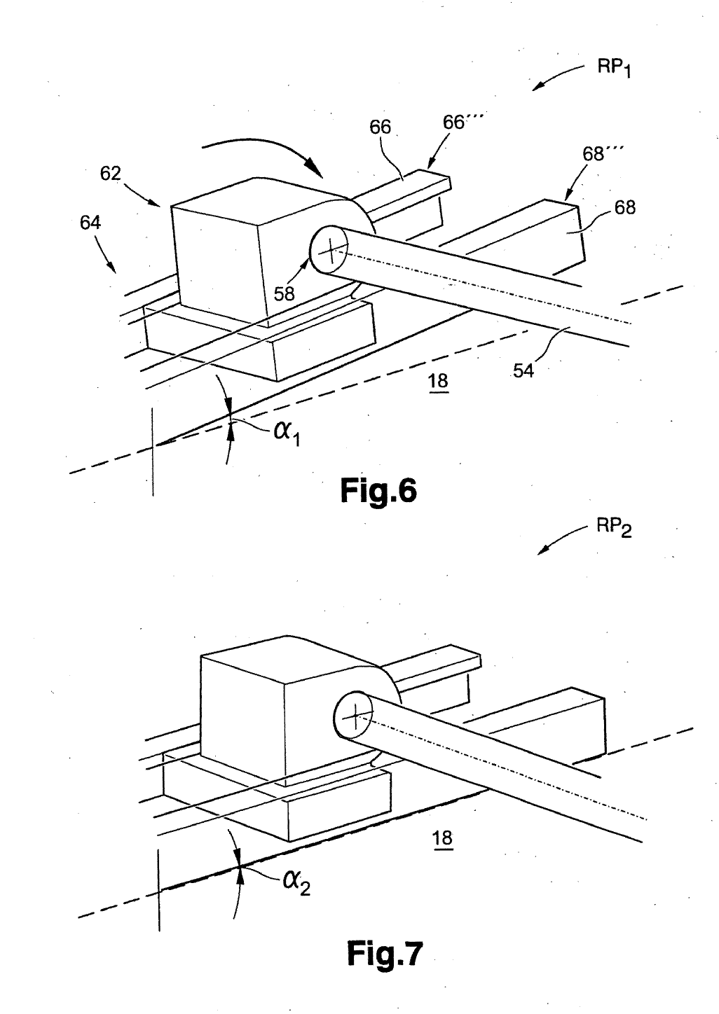

In embodiments of the seat suspension arrangement 14 of the present invention wherein the biasing means 46 comprises a torsion bar 54, the torsion bar 54 may preferably be prestressed by a prestressing method according to a third aspect of the present invention. As such, the prestressing method comprises the following steps: a) positioning the guided member 28 relative to the guide rail 26 such that at least a portion of the guided member 28 and at least a portion of the guide rail 26 overlap; b) imparting a rotation from a first rotational position RPi (see e.g. FIG. 6) to a second rotational position RP2 (see e.g. FIG. 7) of a second portion 58 of the torsion bar 54 to thereby bias the guided member 28 towards the guide rail 26, and—c) locking the second portion 58 in the second rotational position RP2 from rotation.

FIG. 5 illustrates the guided member 28 and the guide rail 26 when they have been position in relation to one another in accordance to step a) of the above method. As a non-limiting example, the position illustrated in FIG. 5 may be obtained by imparting the guided member 28 a displacement in the longitudinal dimension L relative to the guide rail 26 such that the guided member 28 is inserted in the guide rail 26.

The steps b) and c) of the above method will be described hereinbelow with reference to FIGS. 6 and 7.

In an embodiment of the seat suspension arrangement 14 according to FIG. 5 for example, the step b) of the inventive method may be performed according to the following.

As such, the step b) may be performed by slidably attaching the carrier 62 to the control means 64 and providing that the control means 64 forms a firs angle Ci1 with the guide rail 26—or any component of the seat suspension arrangement rigidly connected to the guide rail 26—such that the carrier 62 forms a first angle with the guide rail 26.

Moreover, the second portion 58 is attached to the carrier 62 such that the second portion 58 is in the first rotational position and the second portion 58 is locked from rotation relative to the carrier 62.

Purely by way of example, the second portion 58 of the torsion bar 54 may be fixedly attached to the carrier 62 by means of a splines arrangement (not shown) in order to obtain a rotational lock of the second portion 58 in relation to the carrier 62. As an example, the second portion 58 may be provided with outwardly extending splines (not shown) and the carrier 62 may be provided with an opening with inwardly extending splines (not shown).

The second portion 58 may be attached to the carrier 62 via the splines in a plurality of ways. Purely by way of example, the second portion 58 may be attached to the carrier 62 by introducing the second portion 58 into the opening of the carrier 62. As such the second portion 58 may be imparted a displacement relative to the carrier in the transversal dimension T. Optionally, the carrier 62 may be in two pieces (not shown) attached to one another by means of releasable attachment means, such as bolts (not shown). The second portion 58 may then be attached to the carrier 62 by firstly separating the two pieces of the carrier 62, introducing the second portion 58 between the pieces and attaching together the two pieces to thereby attach the second portion 58 to the carrier 62.

When the second portion 58 is attached to the carrier 62, the carrier 62 is imparted a rotation such that the second portion 58 also is imparted a rotation. In the example illustrated in FIGS. 6 and 7 the carrier 62 is imparted a rotation around an axis of rotation 5 which is substantially parallel to the transversal dimension T.

Moreover, in the FIGS. 6 and 7 example, the carrier 62 is imparted a rotation by imparting a rotation of the control means 64. The rotation of the control means 64 may be achieved in a plurality of ways. Purely by way of example, the rotation may be obtained by applying a load on the end portions 66″′, 68″′ of the control rims 66, 68 comprised in the control means 64. Such a load may be obtained by for example putting weights on the end portions 66″′, 68″′ or by using a tool, such as a hydraulic tool. The control means 64 is the fixedly connected to the guide rail 26, for instance by fixedly attaching the control means 64 to the lower structure 18. Such an attachment may be achieved by for instance a weld joint or a bolt joint (not shown).

If a bolt joint is used for fixedly attaching the control means 64 to the lower structure 18, the bolt joint may also be used for imparting the aforesaid rotation of the control means 64. To this end, the bolt joint may for instance comprise bolts located at the end portions 66′″, 68′″ of the control means 64. As these bolts are tightened in order to rigidly attach the control means 64 and the lower structure 18, the end portions 66′″, 68′″ will be pressed towards the lower structure 18 such that the aforesaid rotation is obtained.

FIG. 8 illustrates a preferred implementation of the intermediate structure 20 which is comprised in the seat suspension arrangement 14 of the present invention. The implementation of the intermediate structure 20 described hereinbelow may be used in connection with any one of the guide assemblies 30 discussed hereinabove.

As may be gleaned from FIG. 8, the intermediate structure 20 comprises two X-shaped links 70, 72. However, in certain embodiments of the seat suspension arrangement 14, it may suffice to have only one X-shaped link 72. Moreover, further embodiments of the seat suspension arrangement 14 may comprise two X-shaped links (not shown in FIG. 8) the constitution and/or function of which differ from one another.

However, in the FIG. 8 implementation, the two links 70, 72 comprise substantially the same components and they function in substantially the same manner. As such, when presenting the constitution and function of the FIG. 2 X-shaped links 70, 72, reference is only made to one of the links 72 since the presentation is equally applicable for the other link 70.

As such, the X-shaped link 72 comprises a first link member 74 and a second link member 76 at least partially forming the substantially X-shaped link 72. A first link upper end 78 is connected to the upper structure 16. A first link lower end 80 is connected to the lower structure 18. In a similar manner, a second link upper end 82 is connected to the upper structure 16. A second link lower end 84 is connected to the lower structure 18.

Preferably, each one of the first and second link members 74, 76 are elongate. Purely by way of example, each one of the first and second link members 74, 76 is made of a metal panel—such as a steel plate. As a non-limiting example, the thickness of the steel plate may be in the order of 4-6 mm.

Moreover, between their upper ends 78, 82 and their lower ends 80, 84 the first and second link members 74, 76 are pivotally connected to one another by means of a connection arrangement 84. Purely by way of example, the connection arrangement 84 may comprise a shaft (not shown) extending through an opening in one or both of the first and second link members 74, 76. Moreover, the shaft is preferably journalled in bearings (not shown) in at least one of the first and second link members 74, 76.

The upper ends 78, 82 and their lower ends 80, 84 of the first and second link members 74, 76 are comprised in four connection arrangements of the X-shaped link 72. A first and a second connection arrangement 86, 90—connected to the upper ends 78, 82—connects the X-shaped link 72 and the upper structure 16. Moreover, a third and a fourth connection arrangement 84, 88—connected to the lower ends 80, 84—connects the X-shaped link 72 and the lower structure 18.

The four connection arrangements 84, 86, 88, 90 are designed so that they together enable that the position of the upper structure 16 in relation to the lower structure 18—preferably in at least the vertical dimension V—may be changed. To this end, at least two of the connection arrangements 82, 84 are adapted to allow a displacement in the plane P of a portion of the X-shaped link 72 in relation to the upper structure 16 and/or the lower structure 18. The aforesaid displacement may for instance be achieved by a connection arrangement comprising a slide member (not shown) which is adapted to slide on a slide surface (not shown) which slide surface extends substantially in the plane P.

As illustrated in FIG. 8, the X-shaped link 72 may also comprise one or two connection arrangements 86, 88 each one of which is adapted to allow only a rotational displacement of a portion of the X-shaped link 72 in relation to the upper structure 16 and/or the lower structure 18. If the X-shaped link 72 includes two such connection arrangements 86, 88, one of those connection arrangements 86 is preferably connecting the X-shaped link 72 to the upper structure 16 whereas the other of those connection arrangements 88 is connecting the X-shaped link 72 to the lower structure 18.

It should be noted that in certain embodiments of the embodiments of the seat suspension arrangement 14 of the present invention, all of the connection arrangements 84, 86, 88, 90 may be adapted to allow a displacement in the plane P of a portion of the X-shaped link 72 in relation to the upper structure 16 and/or the lower structure 18.

Moreover, FIG. 8 illustrates an implementation of a guide assembly 30 wherein the guide rail 26 comprises a first 38 and a second 94 guide surface wherein the first and second guide surfaces are located on opposite sides of the guided member 28. Moreover, the guide assembly comprises a second guided member 96 connected to the connection member 40. Preferably, the first 8 and second 96 guided members are located on either side of the pivot point 42.

Moreover, FIG. 8 illustrates that the seat suspension arrangement illustrated therein comprises two X-shaped links 70, 72 wherein a guide assembly 30 of the second X-shaped link 72 shares the biasing means—which biasing means in the FIG. 8 example is a torsion bar 54—with a guide assembly 98 of the first X-shaped link 70.

It should be realized that the present invention is not limited to the embodiments described hereinabove and illustrated in the drawings. As such, a person skilled in the art will realize that many changes and modifications may be performed within the scope of the appended claims.

1. A seat suspension arrangement (14) comprising an upper structure (16) for receiving a seat and a lower structure (18) for mounting the seat in a work machine or vehicle (10), said upper structure (16) and said lower structure (18) being interconnected by at least one intermediate structure (20) and displaceable towards and away from each other, the seat suspension arrangement (14) comprising a guide rail (26) and a guided member (28) which is connected to the intermediate structure (20) and arranged at the guide rail (26), said guided member (28) being arranged to be displaced forwards and backwards along the guide rail (26) when the upper structure (16) and the lower structure (18) are displaced relative to each other, characterized in that said guided member (28) is connected to the intermediate structure (20) by means of a connection member (40) which is pivotally connected to the intermediate structure (20) at a pivot point (42), said guided member (28) being connected to the connection member (40) at a distance from said pivot point (42), the seat suspension arrangement (14) further comprising a biasing means (46) adapted to impart a torque around said pivot point (42) on the connection member (40) to thereby bias said guided member (28) towards said guide rail (26).

2. The seat suspension arrangement (14) according to claim 1, wherein said guided member (28) comprises a roller.

3. The seat suspension arrangement (14) according to claim 1 or 2, wherein said biasing means (46) is a torsion bar (54), a first portion (56) of said torsion bar (54) being fixedly attached to said connection member (40) at said pivot point (42).

4. The seat suspension arrangement (14) according to claim 3, wherein a second portion (58) of said torsion bar (54) is fixedly attached to a carrier (62), said carrier (62) being adapted to perform a translational displacement which is uniform with a translational displacement of said pivot point (42).

5. The seat suspension arrangement (14) according to claim 4, wherein said carrier (62) is slidably connected to a control means (64), at least a portion of said control means (64) being rigidly connected to said guide rail (26).

6. The seat suspension arrangement (14) according to any one of the preceding claims, wherein said seat suspension arrangement (14) comprises at least two guide assemblies (30), each one of said guide assemblies (30) comprising a guided member (28) and a guide rail (26) according to any one of the preceding claims.

7. The seat suspension arrangement (14) according to any one of the preceding claims, wherein said guide rail (26) comprises a first (34) and a second (98) guide surface wherein said first and second guide surfaces (34, 98) are located on opposite sides of said guided member (28), said seat suspension arrangement further comprises a second guided member (96) connected to said connection member.

8. The seat suspension arrangement (14) according to claim 7, wherein said first and second guided members (28, 96) are located on either side of said pivot point (42).

9. The seat suspension arrangement (14) according to any one of the preceding claims, wherein said intermediate structure (20) comprises a first link member (74) and a second link member (76) at least partially forming a substantially X-shaped link (72) comprising four connection arrangements (84, 86, 88, 90) wherein a first and a second connection arrangement (86, 90) connects said X-shaped link (72) and said upper structure (16) and a third and a fourth connection arrangement (84, 88) connects said X-shaped link (72) and said lower structure (18) to thereby enable that the position of said upper structure (16) in relation to said lower structure (18) may be changed.

10. The seat suspension arrangement (14) according to any one of the preceding claims, wherein said seat suspension arrangement (14) comprises two intermediate structures (20) according to any one of the preceding claims.

11. The seat suspension arrangement (14) according to claim 10, wherein said arrangement (14) comprises a first intermediate structure (70) comprising a first guided member (100), said arrangement further comprising a second intermediate structure (72) comprising a second guided member (28), said first and second guided members (28, 100) being connected to a common biasing means.

12. A vehicle (10), preferably a truck or a work machine, comprising a seat suspension arrangement (14) according to any one of the preceding claims.

13. A method of prestressing a guide assembly (30) of a seat suspension arrangement (14), said guide assembly comprising a torsion bar (54) a first portion of which is fixedly attached to a connection member (40) at a pivot point (42), said guide assembly (14) further comprising a guided member (28) being connected to said connection member (40) at a distance from said pivot point (42), said guide assembly (30) further comprising a guide rail (26) along which guide rail (26) said guided member (26) is adapted to be displaced forwards and backwards, said method comprising the steps of:
a) positioning said guided member (28) relative to said guide rail (26) such that at least a portion of said guided member (28) and at least a portion of said guide rail (26) overlap;
b) imparting a rotation from a first rotational position (RP₁) to a second rotational position (RP₂) of a second portion (58) of said torsion bar (54) to thereby bias said guided member (28) towards said guide rail (26), and
c) locking said second portion (58) in said second rotational position from rotation.

14. The method according to claim 13, wherein said second portion (58) of said torsion bar (54) is adapted to be fixedly attached to a carrier (62) being adapted to be connected to said guide rail (26), wherein in the steps b) and c) of claim 13 comprises the following steps:
positioning said carrier (62) such that said carrier (62) forms a first angle (α₁) with said guide rail;
attaching said second portion (58) to said carrier (62) such that said second portion (58) is in said first rotational position (RP₁) and said second portion (58) is locked from rotation relative to said carrier (62);
imparting a rotation on said carrier (62) such that said carrier (62) forms a second angle (α₂) with said guide rail (26) such that said second portion (58) is imparted a rotation from said first rotational position (RP₁) to said second rotational position (RP₂), and
attaching said carrier (62) to said guide rail (26).

15. The method according to claim 14, wherein said carrier (62) is slidably connected to a control means (64), at least a portion of said control means (64) being adapted to be rigidly connected to said guide rail (26), wherein in the steps of claim 14 further comprises the following steps:
slidably attaching said carrier (62) to said control means (64);
providing that said control means (64) forms a first angle (α₁) with said guide rail (26) before attaching said second portion (58) to said carrier (62) to thereby attain that said carrier (62) forms said first angle (α₁) with said guide rail (26);
imparting a rotation on said control means (64) to thereby impart said rotation on said carrier (62), and
rigidly attaching said control means (64) to said guide rail (26) to thereby attain said attachment of said carrier (62) to said guide rail (26).

16. A seat suspension arrangement comprising an upper structure for receiving a seat and a lower structure for mounting the seat in a work machine or vehicle, said upper structure and said lower structure being interconnected by at least one intermediate structure and displaceable towards and away from each other, the seat suspension arrangement comprising a guide rail and a guided member which is connected to the intermediate structure and arranged at the guide rail, said guided member being arranged to be displaced forwards and backwards along the guide rail when the upper structure and the lower structure are displaced relative to each other, wherein said guided member is connected to the intermediate structure by means of a connection member which is pivotally connected to the intermediate structure at a pivot point, said guided member being connected to the connection member at a distance from said pivot point, the seat suspension arrangement further comprising a biaser adapted to impart a torque around said pivot point on the connection member to thereby bias said guided member towards said guide rail.

17. The seat suspension arrangement according to claim 16, wherein said guided member comprises a roller.

18. The seat suspension arrangement according to claim 16 or 17, wherein said biaser is a torsion bar, a first portion of said torsion bar being fixedly attached to said connection member at said pivot point.

19. The seat suspension arrangement according to claim 18, wherein a second portion of said torsion bar is fixedly attached to a carrier, said carrier being adapted to perform a translational displacement which is uniform with a translational displacement of said pivot point.

20. The seat suspension arrangement according to claim 19, wherein said carrier is slidably connected to a controller, at least a portion of said controller being rigidly connected to said guide rail.

21. The seat suspension arrangement according to any one of claims 16-20, wherein said seat suspension arrangement comprises at least two guide assemblies, each one of said guide assemblies comprising a guided member and a guide rail according to any one of the preceding claims.

22. The seat suspension arrangement according to any one of claims 16-21, wherein said guide rail comprises a first and a second guide surface wherein said first and second guide surface are located on opposite sides of said guided member; said seat suspension arrangement further comprises a second guided member connected to said connection member.

23. The seat suspension arrangement according to claim 22, wherein said first and second guided members are located on either side of said pivot point.

24. The seat suspension arrangement according to any one of claims 16-23, wherein said intermediate structure comprises a first link member and a second link member at least partially forming a substantially X-shaped link comprising four connection arrangements wherein a first and a second connection arrangement connects said X-shaped link and said upper structure and a third and a fourth connection arrangement connects said X-shaped link and said lower structure to thereby enable that the position of said upper structure in relation to said lower structure may be changed.

25. The seat suspension arrangement according to any one of claims 16-24, wherein said seat suspension arrangement comprises two intermediate structures according to any one of the preceding claims.

26. The seat suspension arrangement according to claim 25, wherein said arrangement comprises a first intermediate structure comprising a first guided member, said arrangement further comprising a second intermediate structure comprising a second guided member, said first and second guided members being connected to a common biaser.

27. A vehicle, preferably a truck or a work machine, comprising a seat suspension arrangement according to any one of claims 16-26.

28. A method of prestressing a guide assembly of a seat suspension arrangement, said guide assembly comprising a torsion bar a first portion of which is fixedly attached to a connection member at a pivot point, said guide assembly further comprising a guided member being connected to said connection member at a distance from said pivot point, said guide assembly further comprising a guide rail along which guide rail said guided member is adapted to be displaced forwards and backwards, said method comprising the steps of:
d) positioning said guided member relative to said guide rail such that at least a portion of said guided member and at least a portion of said guide rail overlap;
e) imparting a rotation from a first rotational position to a second rotational position of a second portion of said torsion bar to thereby bias said guided member towards said guide rail, and
f) locking said second portion in said second rotational position from rotation.

29. The method according to claim 28, wherein said second portion of said torsion bar is adapted to be fixedly attached to a carrier being adapted to be connected to said guide rail, wherein in the steps b) and c) of claim 28 comprises the following steps:
positioning said carrier such that said carrier forms a first angle with said guide rail;
attaching said second portion to said carrier such that said second portion is in said first rotational position and said second portion is locked from rotation relative to said carrier;
imparting a rotation on said carrier such that said carrier forms a second angle with said guide rail such that said second portion is imparted a rotation from said first rotational position to said second rotational position, and
attaching said carrier to said guide rail.

30. The method according to claim 29, wherein said carrier is slidably connected to a controller, at least a portion of said controller being adapted to be rigidly connected to said guide rail, wherein in the steps of claim 29 further comprises the following steps:
slidably attaching said carrier to said controller;
providing that said controller forms a first angle with said guide rail before attaching said second portion to said carrier to thereby attain that said carrier forms said first angle with said guide rail;
imparting a rotation on said controller to thereby impart said rotation on said carrier, and
rigidly attaching said controller to said guide rail to thereby attain said attachment of said carrier to said guide rail.
